(19) United States
(12) Patent Application Publication
(10) Pub. No.: US 2005/0160943 A1
(43) Pub. Date: Jul. 28, 2005

(54) Use of dispersed precipitated silica to obtain a dye by mixture with an inorganic pigment, rsulting dye and use for dyeing ceramic materials

(76) Inventor: Gilles Orange, Soisy Sous Montmorency (FR)

Correspondence Address: Jean-Louis Seugnet;Rhodia Inc Intellectual Property Dept, 259 Prospect Plains Road, CN 7500, Cranbury, NJ, 08512-7500, US

(21) Appl. No.: 10/507,234

(22) PCT Filed: Mar. 12, 2003
(86) PCT No.: PCT/FR03/00795

(30) Foreign Application Priority Data
Mar. 12, 2002 (FR) 0203477

(51) Int. Cl. C08L 95/00; C09C 1/22; C04B 14/04

(52) U.S. Cl. 106/481; 106/459; 106/482; 106/275; 106/712

(57) ABSTRACT

The invention concerns the use of dispersed precipitated silica as raw material for obtaining a dye, by mixture with an inorganic pigment, in particular with a inorganic pigment based on an iron compound. The invention also concerns a dye obtainable by calcining a dispersed precipitated silica and an inorganic pigment, in particular an inorganic pigment based on an iron compound. The resulting dye can be used for dyeing ceramic materials, such as ceramic roof tiles or floor tiles, and materials containing hydraulic or bituminous binder.

The present invention relates to the use of precipitated silica in dispersed form as a starting material to obtain a colorant by mixing said silica with an inorganic pigment, in particular with an inorganic pigment based on an iron compound.

The invention also relates to a colorant that may be obtained by calcination, and then optional grinding, of a mixture of precipitated silica in dispersed form and of an inorganic pigment, especially an inorganic pigment based on an iron compound.

The invention also relates to the use of such a colorant for the coloration of ceramic materials, and to the ceramic materials thus colored.

Finally, the invention relates to the use of such a colorant for the coloration of materials containing a hydraulic or asphalt binder, and to the materials containing a hydraulic or asphalt binder thus colored.

Natural or synthetic pigments are used as colorants in the ceramics industry, in particular for the production of colored traditional roofing tiles and paving tiles. In this case especially, the coloration is performed by adding specific pigments to the ceramic paste before forming by pressing and sintering the roofing tiles/paving tiles obtained.

The standard pigments for ceramics are natural products. Thus, Grès de Thiviers, generally comprising about 90% quartz and about 10% goethite (FeOOH), makes it possible to obtain colors from red to brown, which are the main colors traditionally developed for roofing tiles and especially floor tiles, and in particular the stoneware tiles (Grès Porcellenato) obtained according to a fast-firing process.

However, these natural products, for instance Grès de Thiviers, have a certain number of drawbacks: limited coloration properties, inconsistent reproducibility quality, depletion of the natural resources.

Thus, the ceramics industry is increasingly in search of synthetic pigments (colorants) whose properties are equivalent or superior to those of natural pigments.

A new concept of colorant for ceramic materials has recently appeared: it consists in initially including the pigment in a mineral matrix, more particularly silica. The potential advantage of including the pigment in a vitreous or crystalline inert matrix is the great stability with respect to severe thermal and chemical conditions, such as those encountered in the ceramics industry, and has thus allowed the development of novel coloring powders. Furthermore, in the presence of glazing or sintering, this colorant acts as a chromatic unit from the point of view of pigmentation, and the color is not developed by introduction of an ion into the network of the matrix or by formation of a solid solution; the crystals responsible for the coloration are, in point of fact, small crystals included during the process of firing/sintering of the matrix.

One application of this novel concept is the synthesis of red/brown inorganic pigments for ceramic applications, by inclusion of hematite (α-Fe₂O₃) into a silica matrix.

F. Bondioli et al. teach (Materials Research Bulletin, Vol. 33, No. 5, pp. 723-729, 1998) the use of amorphous fumed silica and of synthetic goethite.

U.S. Pat. No. 6,228,160 describes a red/brown colorant prepared by mixing an iron pigment, a silica-based pulverulent matrix and auxiliary additives such as a silicone oil, said mixing rather being performed in dry form; the colorant in this case is obtained directly without the need to carry out a calcination step.

A colorant manufactured from microsilica (or fumed silica) and iron oxide is described in WO 00/53680: the process involves intensive grinding in a wet medium, drying, high-temperature calcination and grinding.

In these processes for manufacturing coloring powder, the mixing between the silica and the iron oxide must be perfect. This implies, for example, that the silica powder must be highly disintegrated by intensive grinding so as to obtain aggregates with a size in the region of or less than that of the iron pigment, i.e. a few microns.

The intensive contact of the silica with the pigment is of great importance in the formation of the color, in particular the production of a high level of red, high gloss and strong intensity (red/brown after firing). This is particularly the case in the presence of intensive grinding of the constituents.

One of the aims of the present invention is to propose an alternative to the known techniques of the prior art, while at the same time dispensing with an intense grinding step and also making it possible to achieve, in particular, very good calorimetric performance qualities (in particular high stability), and while avoiding the drawbacks mentioned above.

With this aim, a first subject of the invention is the use of precipitated silica (advantageously amorphous) in dispersed form (in water) as a starting material to obtain a colorant by mixing said silica with an inorganic pigment.

Said inorganic pigment is preferentially based on a metallic compound (for example a soluble metal salt) and even more preferably based on an iron compound. This iron compound is generally chosen from Fe₂O₃, Fe₃O₄, FeOOH, a soluble iron salt, or mixtures thereof. It may thus consist of powdered iron oxide Fe₂O₃ or Fe₃O₄, or powdered iron hydrate FeOOH. One or more soluble iron salt(s) such as soluble iron nitrate (in powder or solution form) or, preferably, soluble iron sulfate (in powder or solution form), may also be used.

The term “precipitated silica” means any silica obtained by precipitation reaction of a silicate, such as an alkali metal silicate (for example sodium silicate) with an acid (for example sulfuric acid); the silica may be precipitated herein by any method: in particular, addition of acid to a silicate stock solution, or total or partial simultaneous addition of acid and of silicate to a stock solution of water or of silicate solution.

Very advantageously, the precipitated silica in dispersed form that is used consists of:
a filter cake derived from the precipitation reaction, or
an aqueous suspension of precipitated silica, said suspension preferably being obtained by disintegration (fluidization), optionally followed by wet grinding and/or stabilization with an additive, of a filter cake derived from the precipitation reaction; it should be noted, although this does not constitute the preferred variant of the invention, that said precipitated silica suspension used may be the suspension obtained after the precipitation reaction, before the filtration step.

In other words, the silica is precipitated, the suspension obtained is filtered and a filter cake is obtained and is washed if necessary, this cake then possibly being disintegrated.

The precipitated silica preferably has a BET specific surface area of at least 50 m²/g, in particular of at least 90 m²/g and especially between 100 and 400 m²/g, for example between 110 and 250 m²/g.

The BET specific surface area is determined according to the Brunauer-Emmet-Teller method described in “The Journal of the American Chemical Society”, Vol. 60, page 309, February 1938 and corresponding to NF standard T 45007 (November 1987).

In general, 2% to 30% and in particular 5% to 25%, for example 5% to 15%, by weight of inorganic pigment is used relative to the weight of silica (dry equivalent)+pigment.

The precipitated silica in dispersed form advantageously consisting of a filter cake derived from the precipitation reaction, or of a suspension of precipitated silica, preferably obtained by disintegration, optionally followed by stabilization of a filter cake derived from the precipitation reaction, may be very readily mixed with the inorganic pigment, preferably based on a metallic compound, without any grinding or any controlled flocculation process.

The metallic compound is generally introduced in powder form, without prior dissolution.

Optionally, the consistency of the silica/pigment mixture may be adapted especially by adding water so as to obtain a more fluid system, or by adding silica in powder form so as to obtain a drier paste.

The silica/pigment mixture obtained is preferentially subjected to calcination, optionally after preliminary drying (for example at between 80 and 110° C.).

The calcination is generally performed at a temperature of between 400 and 1300° C., especially between 600 and 1300° C. and preferably between 800 and 1200° C. The calcination may thus be performed at a temperature of between 800 and 1000° C. or, even more preferably, at higher temperature, in the present case between 1000 and 1200° C., depending on the calorimetric parameters desired in the final ceramic material after firing.

The calcination time is preferably at least 30 minutes and in particular at least 45 minutes, for example between 45 and 80 minutes.

The calcination is advantageously performed at a temperature of between 1000 and 1200° C. for at least 45 minutes, for example for 45 to 80 minutes.

The calcination is usually followed by grinding (or crushing), especially in order to obtain the desired particle size.

A fine powder of colorant is thus obtained, for example having a BET specific surface area of between 15 and 75 m²/g, in particular between 20 and 50 m²/g and especially between 20 and 40 m²/g.

A subject of the invention is also a colorant (which may be) obtained by calcination, followed by optional grinding, of a mixture of precipitated silica in dispersed form and of an inorganic pigment.

The preceding description also applies to this subject of the invention.

The colorant according to the invention or derived from the use of precipitated silica in dispersed form according to the invention is particularly suitable for coloring ceramic materials, for example sandstone materials, especially stoneware (Grès Porcellenato) materials, on account of its very good calorimetric properties; it gives them, in particular in the case where the initial inorganic pigment used is based on an iron compound, in particular high gloss and high intensity (red/brown). The invention may also make it possible to not use auxiliary additives such as a silicone oil or a silane. Furthermore, it is not necessary to resort to sol-gel type techniques, for instance controlled flocculation of the silica.

The colorant, in powder form, may be mixed with the ceramic paste before forming by pressing and (after optional drying) firing/sintering at high temperature (in particular between 1000 and 1300° C., for example between 1200 and 1250° C.), especially for 20 to 150 minutes, for example between 25 and 70 minutes or between 45 and 90 minutes, of total cycle (coloration in the bulk).

In general, 1% to 10% by weight, for example 2% to 7% by weight, of colorant are used to 90% to 99% by weight, for example 98% to 93% by weight, of ceramic paste (percentage expressed relative to the total weight of colorant+ceramic paste).

The ceramic materials, for example formed from sandstone, especially stoneware (Grès Porcellenato), containing at least one colorant as described above constitute one of the subjects of the invention. The calorimetric parameters of said sintered ceramic materials, determined by the CIE method, may be, for example, such that: L<65, especially L<60; a>10 (in particular when the calcination is performed at a temperature of between 1000 and 1200° C., for at least 45 minutes); b>10 (for example, b=19 to 20 for yellow-ochre colors and b=13 to 14 for brick-red colors).

These ceramic materials may especially be roofing tiles, paving tiles, for example stoneware tiles (Grès Porcellenato), in particular of red to brown color when the initial inorganic pigment used is based on an iron compound.

They may also be glazes based on mixtures of oxides, the enamel slip then being deposited on the biscuit before firing (surface coloration).

The colorant according to the invention or derived from the use of precipitated silica in dispersed form according to the invention is also suitable for coloring materials containing hydraulic or asphalt binder. These materials containing hydraulic or asphalt binder, containing at least one such colorant, also constitute one of the subjects of the invention.

The examples that follow illustrate the invention without, however, limiting its scope.

### EXAMPLE 1

The filter cake of Z145 silica (precipitated silica sold by the Applicant), derived from the precipitation reaction of this silica, is mixed with goethite-type iron oxide (iron hydroxide) FeOOH (sold by the company Johnson Matthey) in powder form: introduction of the powder during the blending of the cake. The proportions are as follows: 10% by weight of Fe₂O₃ and 90% by weight of silica (dry equivalent) (6.6% iron content).

The mixing is performed by blending for 25 minutes at 100 rpm (internal blender, Brabender type). The product obtained is then dried at 90° C. for six hours, and then calcined at 1020° C. for 5 minutes.

After calcination, the product is coarsely crushed so as to obtain a fine powder of colorant: the particle size is set by screening at 100 μm.

The colorant thus prepared is introduced into a ceramic paste of sandstone type (Grès Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours), and then introduced into a sintering oven. The sintering is performed in a dynamic oven, at 1220° C.-10 minutes, for a total cycle of 35 minutes.

The calorimetric parameters of the sintered ceramic material, determined by the CIE method, are such that: L=61.0; a=3.5; b=13.7.

### EXAMPLE 2

The filter cake of Z145 silica (precipitated silica sold by the Applicant), derived from the precipitation reaction of this silica, is mixed with iron III sulfate (sold by the company Prolabo) in powder form: introduction of the powder during the blending of the cake. The proportions are as follows: 10% by weight of Fe₂O₃ and 90% by weight of silica (dry equivalent) (6.6% iron content).

The mixing is performed by blending for 25 minutes at 100 rpm (internal blender, Brabender type). The product obtained is then dried at 90° C. for six hours, and then calcined at 1020° C. for 5 minutes.

After calcination, the product is coarsely crushed so as to obtain a fine powder of colorant: the particle size is set by screening at 100 μm.

The colorant thus prepared is introduced into a ceramic paste of sandstone type (Grès Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours), and then introduced into a sintering oven. The sintering is performed in a dynamic oven, at 1220° C.-10 minutes, for a total cycle of 35 minutes.

The calorimetric parameters of the sintered ceramic material, determined by the CIE method, are such that: L=56.8; a=7.9; b=14.1.

### EXAMPLE 3

The filter cake of Z145 silica (precipitated silica sold by the Applicant), derived from the precipitation reaction of this silica, is mixed with iron III sulfate (sold by the company Prolabo) in powder form: introduction of the powder during the blending of the cake. The proportions are as follows: 10% by weight of Fe₂O₃ and 90% by weight of silica (dry equivalent) (6.6% iron content).

The mixing is performed by blending for 25 minutes at 100 rpm (internal blender, Brabender type). The product obtained is then dried at 90° C. for six hours, and then calcined at 1020° C. for 60 minutes.

After calcination, the product is coarsely crushed so as to obtain a fine powder of colorant: the particle size is set by screening at 100 μm.

The colorant thus prepared is introduced into a ceramic paste of sandstone type (Grès Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours), and then introduced into a sintering oven. The sintering is performed in a dynamic oven, at 1225° C.-10 minutes, for a total cycle of 60 minutes.

The calorimetric parameters of the sintered ceramic material, determined by the CIE method, are such that: L=52.4; a=11.6; b=13.2.

The increase in the calcination time at 1020° C., relative to Example 2, made it possible especially to increase the level of red (a).

### EXAMPLE 4

The filter cake of Z145 silica (precipitated silica sold by the Applicant), derived from the precipitation reaction of this silica, is mixed with iron III sulfate (sold by the company Prolabo) in powder form: introduction of the powder during the blending of the cake. The proportions are as follows: 10% by weight of Fe₂O₃ and 90% by weight of silica (dry equivalent) (6.6% iron content).

The mixing is performed by blending for 25 minutes at 100 rpm (internal blender, Brabender type). The product obtained is then dried at 90° C. for six hours, and then calcined at 1100° C. for 60 minutes.

After calcination, the product is coarsely crushed so as to obtain a fine powder of colorant: the particle size is set by screening at 100 μm.

The colorant thus prepared is introduced into a ceramic paste of sandstone type (Grès Porcellenato), in the following proportions: 4% by weight of colorant and 96% by weight of ceramic paste.

After aqueous-phase homogenization, followed by drying and deaggregation, the composition obtained is moistened with 4% by weight of water and then formed by pressing so as to obtain pellets. The pellets are then dried at 120° C. (for six hours), and then introduced into a sintering oven. The sintering is performed in a dynamic oven, at 1225° C.-10 minutes, for a total cycle of 60 minutes.

The calorimetric parameters of the sintered ceramic material, determined by the CIE method, are such that: L=56.4; a=13.0; b=15.5.

The raising of the calcination temperature, relative to Example 3, made it possible especially to increase the level of red (a) and the level of yellow (b).

1-29. (canceled)

30. A process for the preparation of an inorganic colorant comprising the step of mixing a precipitated silica in dispersed form with an inorganic pigment to obtain said colorant.

31. The process as claimed in claim 30, wherein said inorganic pigment is based on a metallic compound and, optionally, based on an iron compound.

32. The process as claimed in claim 31, wherein said metallic compound is Fe₂O₃, Fe₃O₄, FeOOH or a soluble iron salt.

33. The process as claimed in claim 32, wherein said metallic compound is powdered Fe₃O₄, powdered FeOOH, soluble iron sulfate or soluble iron nitrate.

34. The process as claimed in claim 33, wherein said metallic compound is powdered FeOOH or powdered soluble iron sulfate.

35. The process as claimed in claim 30, wherein said silica in dispersed form consists of a filter cake derived from a precipitation reaction.

36. The process as claimed in claim 35, wherein said silica in dispersed form consists of an aqueous suspension of precipitated silica, said suspension being obtained by disintegration, optionally followed by wet grinding and/or stabilization with an additive, of the filter cake derived from the precipitation reaction.

37. The process as claimed in claim 30, wherein said precipitated silica has a BET specific surface area of at least 50 m²/g, and, optionally, between 100 and 400 m²/g.

38. The process as claimed in claim 30, wherein 2% to 30% by weight of the inorganic pigment, relative to the weight of silica (dry equivalent)+pigment, is mixed with said silica.

39. The process as claimed in claim 30, wherein the silica/pigment mixture obtained is further subjected to calcination and then, optionally, to grinding.

40. The process as claimed in claim 39, wherein the calcination is performed at a temperature of between 600 and 1300° C.

41. The process as claimed in claim 40, wherein the calcination is performed at a temperature of between 1000 and 1200° C.

42. The process as claimed in claim 39, wherein the calcination time is performed at least 30 minutes.

43. A ceramic material, comprising at least one colorant obtained by the process of claim 30.

44. The ceramic material as claimed in claim 43, formed from sandstone.

45. A roofing tile or paving tile, consisting of a ceramic material according to claim 44.

46. An hydraulic or asphalt binder, comprising at least one colorant obtained by the process of claim 30.
